(19) United States
(12) Patent Application Publication
(10) Pub. No.: US 2008/0182011 A1
(43) Pub. Date: Jul. 31, 2008

(54) METAL AND METAL OXIDE CIRCUIT ELEMENT INK FORMULATION AND METHOD

(76) Inventors: Hou T. Ng, Campbell, CA (US); Alfred I-Tsung Pan, Palo Alto, CA (US)

Correspondence Address: HEWLETT-PACKARD COMPANY;Intellectual Property Administration, P.O. Box 272400, Fort Collins, CO, 80527-2400, US

(21) Appl. No.: 11/627,922

(22) Filed: Jan. 26, 2007

(51) Int. Cl. H01C 17/06; C09D 11/00

(52) U.S. Cl. 427/99.4; 106/31.92

(57) ABSTRACT

An ink formulation of a circuit element includes a first powder having a first melting temperature, a second powder having a second melting temperature that is higher than the first melting temperature, and a polymer binder. A method of fabricating a circuit element on a substrate employs the ink formulation and includes depositing the ink formulation on a substrate, curing the polymer binder, and melting the first powder at the first melting temperature to yield a solid solution that forms the circuit element.

### BACKGROUND

1. Technical Field

The invention relates to printed electrical circuits. In particular, the invention relates to circuit elements fabricated from micro-scale and nano-scale particles and powders.

2. Description of Related Art

The use of low cost substrates as well as a general interest in low cost electronic circuit fabrication has fueled an ongoing search for new circuit element fabrication techniques. In particular, much attention and effort is currently focused on developing techniques for forming either or both of metal circuit elements and metal oxide circuit elements (e.g., conductor traces or semiconductor components) on such substrates. For example, paper substrates are being considered for a wide variety of applications including, but not limited to, radio frequency identification (RFID) tags for marking and tracking packages in retail environments. Flexible plastic substrates are of general interest in a number of current and future display applications. Furthermore, new fabrication techniques compatible with such low cost substrates that also provide potential cost advantages in terms of using low cost materials and being compatible with high volume production systems are likewise of great interest.

Conventional circuit element fabrication techniques often one or more of fail to be compatible with low temperature substrates, fail to provide high performance circuitry, and depend on the use of high cost materials and fabrication systems. In particular, conventional techniques for fabricating high performance conductive circuitry (e.g., conductor traces or conductive interconnects) on a substrate often employ high processing temperatures in excess of 500 degrees Celsius (° C.) that are incompatible with many low cost substrates. For example, circuit elements fabricated using gold, copper or silver based thick film inks generally require processing temperatures for sintering well in excess of 600° C. Thin film circuit fabrication methodologies, such as evaporation or sputter deposition, also typically employ or involve relatively high temperatures. Similarly, techniques including, but not limited to, chemical vapor deposition (CVD) for producing semiconductor circuit elements likewise generally subject substrates to high temperatures.

Organic-based conductor and semiconductor fabrication techniques provide a means for producing circuit elements at lower processing temperatures. However, such organic-based techniques use metal-loaded or semiconductor-loaded epoxy materials that often fail to provide acceptable electrical performance (e.g., conductivity or electron mobility). Moreover, many organic-based techniques often depend on inherently expensive materials (e.g., silver particles).

### BRIEF SUMMARY

In some embodiments of the present invention, an ink formulation of a metal oxide circuit element is provided. The ink formulation comprises a first powder that comprises particles of a metal having a first melting temperature. The ink formulation further comprises a second powder that comprises particles having a second melting temperature that is higher than the first melting temperature. The ink formulation further comprises a polymer binder and an oxidative environment. When cured, the cured polymer binder binds together in close proximity the particles of the first powder and the particles of the second powder. When melted in the oxidative environment, the melted particles of the first powder form the metal oxide circuit element.

In other embodiments of the present invention, an ink formulation to form a circuit element on a substrate is provided. The ink formulation comprises a first metal powder having a first melting temperature. The ink formulation further comprises a second powder having a second melting temperature. The second melting temperature is higher than the first melting temperature. The ink formulation further comprises a polymer that is a thermoplastic. Respective particles of the first metal powder and the second powder are encapsulated by the polymer. Either the first metal powder being melted or both the first metal powder and the second powder being melted forms the circuit element. In other embodiments of the present invention, methods of fabricating a circuit element on a substrate are provided.

Certain embodiments of the present invention have other features that are one or both of in addition to and in lieu of the features described hereinabove. These and other features of the invention are detailed below with reference to the following drawings.

### BRIEF DESCRIPTION OF THE DRAWINGS

The various features of embodiments of the present invention may be more readily understood with reference to the following detailed description taken in conjunction with the accompanying drawings, where like reference numerals designate like structural elements, and in which:

FIG. 1 illustrates a block diagram of an ink formulation that produces a circuit element on a substrate according to an embodiment of the present invention.

FIGS. 2A-2D illustrate a sequence of stages in fabricating an exemplary metal oxide circuit element according to an embodiment of the present invention.

FIGS. 3A-3F illustrate a sequence of stages of fabricating an exemplary circuit element according to another embodiment.

FIG. 4 illustrates a flow chart of a method of fabricating a circuit element on a substrate according to an embodiment of the present invention.

### DETAILED DESCRIPTION

Embodiments of the present invention facilitate fabricating a circuit element on a substrate. In some embodiments, the circuit element is a conductive circuit element. For example, the circuit element may be a conductive interconnect or circuit trace, a conductive pad (e.g., bonding pad or device attachment pad), or another patterned conductive circuit element. In some embodiments, the conductive circuit element comprises one or more of a metal, a metal alloy and a conductive metal oxide. In other embodiments, the circuit element comprises a semiconductor and the circuit element is a semiconductor circuit element. For example, the semiconductor may comprise a metal oxide having semiconductor properties (e.g., ZnO). The semiconductor circuit element may be used to realize a channel of a transistor (e.g., a thin film ZnO transistor), for example.

Embodiments of the present invention produce the circuit element at relatively low temperatures compared to conventional metal-based and metal oxide-based circuit element fabrication methodologies. In particular, various embodiments of the present invention are adapted to producing the circuit element at processing temperatures that are less than about 500 degrees Celsius (° C.). The circuit element may be produced at temperatures below about 300° C., according to some embodiments of the present invention. The relatively low fabrication temperatures attributable to the present invention facilitate producing circuit elements on low temperature substrates such as, but not limited to, paper substrates and various polymer substrates. However, circuit elements also may be produced on inherently high temperature substrates according to the present invention. For example, circuit elements may be produced on substrates comprising materials including, but not limited to, various glasses and ceramic (e.g., alumina), silicon (Si), and silicon dioxide (SiO₂).

The present invention is adapted to producing the circuit element on a substrate using an additive patterning technique. In additive patterning, a pattern or shape and extent of the circuit element is defined prior to processing of a precursor material into a final conductor or semiconductor form of the circuit element. For example, according to the present invention, the circuit element may be produced by processing an ink formulation following deposition on a substrate. Processing (e.g., heating) transforms the ink formulation into a final form (e.g., a metal oxide) that constitutes the circuit element. In some such embodiments, a pattern or shape of the circuit element is defined during or as a result of deposition on the substrate. Examples of additive patterning that may be used for depositing the ink formulation include, but are not limited to, gravure printing, thermal ink-jet printing, screen printing, dip-coating, spin coating, imprinting (e.g., imprint lithography), and laminating. In other embodiments, subtractive patterning such as, but not limited to, etching is used to either pattern the circuit element after processing or further pattern the circuit element after additive patterning during deposition.

In some embodiments, the substrate upon which the circuit element is fabricated is an essentially rigid substrate. Rigid substrates include, but are not limited to, a glass panel, a silicon wafer, a silicon-on-insulator (SOI) wafer, a group II-VI compound semiconductor wafer, a group III-V compound semiconductor wafer, an anodized metal sheet, a sapphire wafer, and an alumina (Al₂O₃) substrate. In other embodiments, the substrate is an essentially flexible substrate, such as a polymeric (e.g., plastic) film or sheet and paper. Exemplary polymers and plastics available as flexible sheets include, but are not limited to, high density polyethylene (HDPE), low density polyethylene (LDPE), polyethylene terephthalate (PET or Mylar®), cellulose acetate, polyvinyl chloride (PVC), polyimide (e.g., Kapton®), and various other commonly available plastics. Mylar® and Kapton® are registered trademarks of E. I. Du Pont De Nemours and Company Corporation, Delaware.

In some embodiments, either the rigid substrate or the flexible substrate further comprises one or more layers of coating materials applied on the substrate surface. For example, an epoxy coating may be applied to an alumina substrate. The epoxy coating may reduce a surface roughness of the substrate, for example. In another example, one or more of an insulator layer (e.g., SiO₂) and a conductor layer (e.g., polysilicon, metal, etc.) may be either grown or applied to the native substrate surface. An insulator layer may be employed to electrically isolate the circuit element from the underlying substrate, for example. For simplicity of discussion only, no distinction is made herein between the substrate by itself and the substrate having additional layers unless such distinction is necessary for proper understanding.

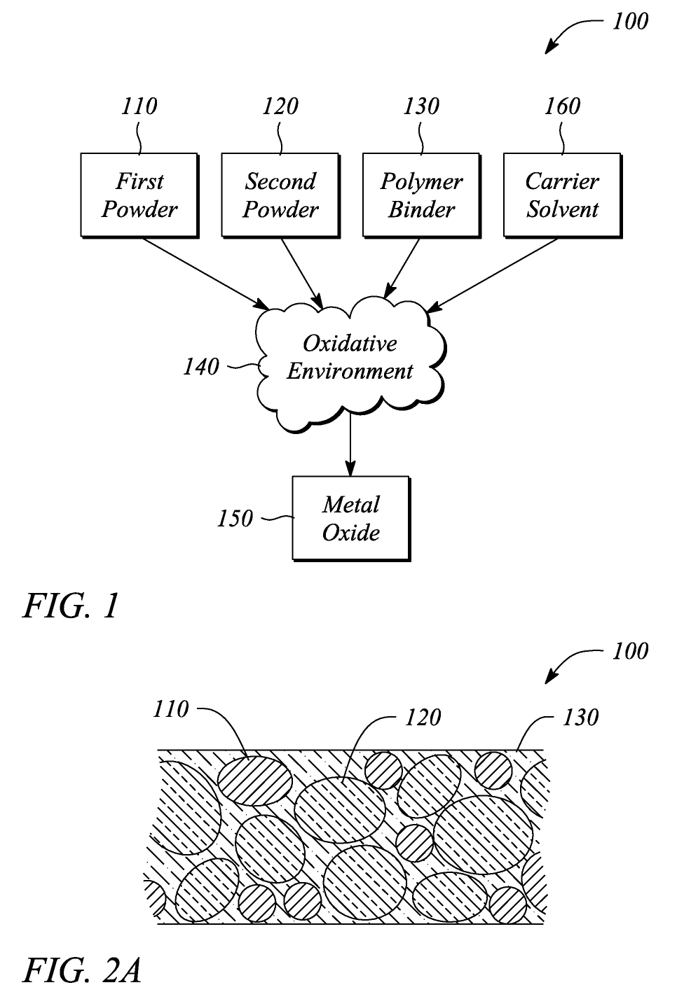

FIG. 1 illustrates a block diagram of an ink formulation 100 that produces a metal oxide circuit element on a substrate according to an embodiment of the present invention. The metal oxide circuit element formed by the ink formulation 100 has characteristics of either a conductor or a semiconductor. The ink formulation 100 produces the metal oxide circuit element after being deposited and processed on the substrate. A shape and extent of the metal oxide circuit element may be defined during deposition, in some embodiments.

As illustrated in FIG. 1, the ink formulation comprises a first powder 110. The first powder 110 comprises a metal having a first melting temperature. The metal of the first powder 110 may be either an elemental metal (i.e., essentially pure metal) or a metal alloy. Metal alloys, including binary, ternary and more complex alloys, may be employed according to various embodiments.

In some embodiments, the first powder 110 comprises a metal having a relatively low first melting temperature. As used herein, a low melting temperature metal has a melting temperature below about 500° C. For example, indium (In) having a melting temperature of about 157° C and tin (Sn) having a melting temperature of about 232° C are low melting temperature metals. Other low melting temperature metals include, but are not limited to, mercury (Hg), gallium (Ga), selenium (Se), polonium (Po), bismuth (Bi), thallium (Tl), cadmium (Cd), lead (Pb), zinc (Zn) and tellurium (Te). The low melting temperature metal of the first powder 110 may comprise a metal alloy of two or more of the metals listed above that has an alloy melting point below about 500° C. For example, an alloy of In and Sn is employed as the metal of the first powder 110. In another example, an alloy of Ga and Zn, or an alloy of In, Ga, and Zn is employed.

Other low melting temperature metal alloys that may be employed include, but are not limited to, eutectic and non-eutectic solders. For example, the first powder 110 may comprise a metal alloy such as In52/Sn48 solder (i.e., 52% In and 48% Sn) having a eutectic melting point of 118° C. In another example, particles of Sn60/Pb40 solder with a melting point (m.p.) below about 190° C. are employed for the first powder 110. In yet other examples, metal alloys such as Sn91/Zn9 (m.p. 1990 C) or In70/Pb30 (m.p. 175° C.), are employed for the first metal powder 110.

In some embodiments, the low melting temperature metal of the first powder 110 comprises an alloy that includes one or more inherently high melting temperature metals such as, but not limited to, antimony (Sb), copper (Cu), gold (Au) and silver (Ag) instead of or in addition to the low melting temperature metals listed above. For example, various alloys of Sb, Ag, and Cu have melting points below about 230° C. (e.g., a Sn96.5/Ag3.0/Cu0.5 alloy, m.p. 217-220° C; a Sn99.3/Cu0.7 alloy, m.p. 227° C.; and a Sn96.5/Ag3.5 alloy, m.p. 221° C). A Sn95/Sb5 alloy has a melting point of 232-240° C. while a Sn90/Au10 alloy forms a eutectic with a melting point of 217° C.

Referring again to FIG. 1, the ink formulation 100 further comprises a second powder 120. Particles of the second powder have a second melting temperature that is higher than the first melting temperature. In some embodiments, the particles of the second powder comprise a metal that is either an elemental (i.e. essentially pure) metal or a metal alloy. Metal alloys including binary, ternary and more complex alloys may be employed as the second powder 120, according to various embodiments. In some embodiments, the metal of the second powder 120 comprises one or more of the low melting temperature metals Hg, In, Ga, Se, Po, Bi, Tl, Cd, Pb, Zn and Te, and alloys thereof. In other embodiments, the metal of the second powder 120 comprises an inherently high melting temperature metal including, but not limited to, antimony (Sb), aluminum (Al), silver (Ag), gold (Au), copper (Cu), beryllium (Be), nickel (Ni), cobalt (Co), yttrium (Y), iron (Fe), palladium (Pd), titanium (Ti), platinum (Pt) and molybdenum (Mo). In yet other embodiments, the second powder 120 comprises an alloy of one or more high melting temperature metals and one or more low melting temperature metals.

In some embodiments, the second powder 120 comprises one or more non-metals including, but not limited to hydrogen (H), carbon (C), silicon (Si), nitrogen (N), and oxygen (O), in addition to a metal. For example, the second powder 120 may comprise zinc oxide (ZnO) particles. In another example, the second powder 120 may comprise particles of tin oxide (SnO) or indium tin oxide (ITO).

In some embodiments, the particles of one or both of the first powder 110 and the second powder 120 are nano-sized particles or nanoparticles. As used herein, nanoparticles are particles having a Feret diameter of less than approximately 200 nanometers (nm). In some embodiments, the Feret diameter is less than approximately 100 nm. In other embodiments, the particles of one or both of the first powder 110 and the second powder 120 are micro-sized particles or microparticles having a Feret diameter of less than about 10 microns (μm). In some embodiments, the Feret diameter is less than approximately 1 μm. In yet other embodiments, one or both of the first powder 110 and the second powder 120 comprises a mixture of nanoparticles and microparticles. In yet other embodiments, particles larger than microparticles are used in addition to or instead of one or both of nanoparticles and microparticles. For example, the first powder 110 may comprise nanoparticles while the second powder 120 comprises a combination of microparticles and larger particles.

In some embodiments, nanoparticles of the respective powder are employed to reduce a melting temperature of the powder. In particular, use of nanoparticles of a material will depress the melting temperature the material and therefore, some embodiments herein take advantage of the melting point depression associated with such nanoparticle sizes. For example, a powder comprising Zn nanoparticles (e.g., having a Feret diameter of 5-10 nm) may be employed to reduce a melting point of the Zn to well below 420° C. by virtue of melting point depression.

In general, the particles of the respective first and second powders 110, 120 may have essentially any shape or combination of shapes including, but not limited to, spherical, rod-shaped, rectilinear, and flake-like or quasi-planar. In some embodiments, spherical or near spherical shaped particles are employed to facilitate close packing of the particles within the ink formulation 100 after deposition on the substrate. Using a mixture of larger and smaller particles may further enhance close packing of the particles with in the ink formulation 100.

Referring again to FIG. 1, the ink formulation 100 further comprises a polymer binder 130. The polymer binder 130 acts to hold the particles of the first powder 110 and the second powder 120 together following deposition of the ink formulation 100 on the substrate. In particular, a matrix of the polymer binder 130 binds together the particles and holds the particles in close proximity to one another after the polymer binder 130 is cured on the substrate. In some embodiments, the polymer binder 130 provides an average separation of the particles that is less than an average Feret diameter of the particles. For example, the particles may be essentially touching one another within a matrix of the polymer binder 130.

In some embodiments, the polymer binder 130 comprises a polymer compound in the ink formulation 100 prior to deposition and curing. For example, the polymer compound may be dissolved in a solvent of the ink formulation 100 prior to deposition. Following deposition, the polymer binder 130 is cured by removing the solvent (e.g., by evaporation). Curing establishes (or reestablishes) the polymer matrix that incorporates and binds the particles together. In some embodiments, a fully polymerized polymer compound is dissolved in the solvent. The polymer compound either partially or completely de-polymerizes when dissolved and essentially re-polymerizes upon removal of the solvent. The re-polymerization establishes the polymer matrix around the particles of the first powder 110 and the second powder 120. The established polymer matrix formed around the particles binds the particles together.

In another example, the polymer binder 130 comprises a liquid state of the polymer compound prior to deposition. After deposition, the liquid polymer compound is transformed through curing to a solid form. The solid form establishes the polymer matrix around the particles effectively binding together the particles of the first and second powders 110, 120.

In yet another example, the polymer binder 130 comprises a polymer compound in the form of a powder in the ink formulation 100 prior to deposition. Following the deposition, the polymer binder 130 is cured by heating to melt or partially melt the polymer compound powder, for example. The melting effectively incorporates and binds together the particles of the first powder 110 and the second powder 120 within the polymer matrix of the polymer binder 130.

In other embodiments, the polymer binder 130 comprises a polymer precursor or a plurality of polymer precursors prior to deposition and curing. Curing the polymer precursor transforms the precursor(s) into the polymer binder 130 through polymerization to form the polymer matrix. For example, the polymer binder 130 may comprise a monomer as the polymer precursor prior to deposition and curing. Following deposition, curing polymerizes the monomer to produce the polymer matrix of the polymer binder 130. The polymerization of the polymer precursor incorporates and binds the particles of the first powder 110 and the second powder 120 within the matrix of the polymer binder 130. Polymerization may include cross-linking.

In some embodiments, the polymer binder 130 comprises a thermoplastic. In some such embodiments, a melting temperature (e.g., glass transition temperature) of the polymer binder 130 is less than the melting temperature of the metal of the first powder 110. For example, the polymer binder 130 may be essentially liquid at a melting temperature of the first powder 110. The liquid state of the polymer binder 130 allows the melted first powder 110 to flow freely around particles of the second powder 120. Alternatively, the polymer binder 130 may evaporate, sublimate, or otherwise essentially decompose at a temperature less than or equal to the melting temperature of the first powder such that the polymer binder 130 does not hinder a flowing of the melted first powder 110 in and around the particles of the second powder 120. Examples of thermoplastics useful as the polymer binder 130 include, but are not limited to, polystyrene, polyethylene, polyethylene terephthalate, polymethyl methacrylate, polycarbonate, polyvinylpyrolidone, polyvinyl alcohol (PVA), polyvinylchloride (PVC), and polyethene oxide.

In some embodiments, the polymer binder 130 comprises an encapsulating polymer. The encapsulating polymer is defined as a polymer that coats or encapsulates individual particles of one or both of the first powder 110 and the second powder 120 within the ink formulation 100 prior to deposition and curing. For example, particles of the first powder 110 may be prepared by encapsulating metal particles thereof in a polymer compound prior to use in the ink formulation 100. Particles of the second powder 120 may be similarly encapsulated, in some embodiments.

Encapsulating may be performed by exposing the particles to be encapsulated to a solution containing a surfactant-like molecule having a hydrophobic portion and a hydrophilic portion where the hydrophilic portion is a monomer of the encapsulating polymer. When exposed, the hydrophobic portion is attracted to a surface of the particle such that the hydrophilic portion is facing outwards away from the particle. The hydrophilic portion is then be polymerized to form a thin shell of the encapsulating polymer that essentially covers the particle. Alternatively, encapsulating may be performed using various other techniques including, but not limited to, a supercritical antisolvent or supercritical fluidic process and Discrete Particle Encapsulation. Discrete Particle Encapsulation is a particle encapsulation process of Nanophase Technologies Corporation, Burr Ridge, Ill.

In some embodiments, the encapsulating polymer of the polymer binder 130 is cured following deposition by sintering the encapsulated particles. The encapsulated particles are sintered by heating to at least a glass transition temperature of the encapsulating polymer. At the glass transition temperature, the encapsulating polymer begins to soften allowing partial merging of adjacent particles. Merging both solidifies the deposited ink formulation 100 as well as facilitates binding together in close proximity adjacent particles of the first powder 110 and the second powder 120. In some embodiments, following curing (e.g., sintering), adjacent particles of the first and second powders 110, 120 are essentially in contact with one another.

A thickness of the encapsulating polymer is generally controlled during the encapsulation to ensure the close packing of the particles following deposition and curing. As such, the encapsulating polymer is generally thinner than an average Feret diameter of the particle(s) being encapsulated. In some embodiments, the thickness of the encapsulating polymer is less than about one tenth the average Feret diameter.

Referring again to FIG. 1, the ink formulation 100 further comprises an oxidative environment 140, according to some embodiments. In particular, the ink formulation 100 comprises the oxidative environment 140 during processing into a metal oxide 150. The oxidative environment 140 is present during melting of either the first powder 110 or melting of both the first powder 110 and the second powder 120. As used herein, the oxidative environment 140 is defined as a source of oxygen (O) that actively participates in forming a metal oxide. Specifically, the oxidative environment 140 adds oxygen atoms (O) to the metal or metals to form an oxide or oxides thereof. In some embodiments, the metal(s) is essentially fully oxidized by the oxidative environment 140.

In some embodiments, the oxidative environment comprises oxygen (O₂) gas present in an atmosphere surrounding the ink formulation 100 during processing following deposition. For example, the substrate upon which the ink formulation 100 is deposited may be heated in the presence of an oxygen/nitrogen (O₂/N₂) atmosphere to a temperature sufficient to melt one or both of the first powder 110 and the second powder 120. In some such embodiments, the O₂/N₂ atmosphere is “oxygen rich” comprising greater than or equal to 50% O₂ gas. For example, the deposited ink formulation 100 may be subjected to an oxygen rich atmosphere comprising about 55% O₂ and 45% nitrogen (N₂) by volume. Presence of high levels of O₂ gas facilitates essentially complete oxidation of the melted metal(s).

In some embodiments, the oxidative environment 140 comprises a polymer of the polymer binder 130. In particular, the polymer binder 130 provides some or all of the oxygen (O) atoms for producing the metal oxide 150, according to some embodiments. For example, when using polyvinyl alcohol (PVA) as the polymer binder 130, the oxygen (O) may be provided by an O—H group of the PVA. In another example of a polymer-derived oxidative environment, the oxygen (O) is provided by an oxide in polyethene oxide that is used as the polymer binder 130. A polymer-derived oxidative environment 140 is particularly useful when the polymer binder 130 is the encapsulating polymer.

In some embodiments, the ink formulation 100 further comprises a solvent carrier 160. The carrier solvent 160 may be a simple solvent carrier or an active solvent carrier. As used herein, a ‘simple solvent carrier’ or ‘simple solvent’ is a liquid used primarily to suspend constituents of the ink formulation 100 prior to and during deposition. The simple solvent carrier is a passive or non-reactive solvent that has little or no chemical activity relative to the ink formulation 100. As such, the simple solvent carrier comprises an essentially chemically inert liquid with respect to the ink formulation 100. For example, the carrier solvent 160 may comprise water (H₂O) in which the first powder 110, the second powder 120 and the polymer binder 130 are mechanically suspended for deposition. Suspension may be achieved by ultrasonification, for example. Beyond mechanical suspension, the exemplary water-based carrier solvent 160 provides no additional chemical activity in this example.

In contrast, an ‘active carrier solvent’ or ‘active solvent’ provides some chemical activity when used in the ink formulation 100. For example, the carrier solvent 160 may serve to dissolve the polymer binder 130. Removal of the carrier solvent 160 following deposition and during curing may induce polymerization (or re-polymerization) to produce the polymer matrix of the polymer binder 130. An aromatic hydrocarbon, such as, but not limited to, toluene and xylene, may be employed as an active carrier solvent when the polymer binder 130 comprises polyethylene, for example. In another example, when the polymer binder 130 comprises polyvinyl alcohol (PVA), which is water soluble, a water-based carrier solvent 160 may be used as an active solvent. In some embodiments, a polymer precursor in a liquid state may serve as the carrier solvent 160 in addition to being a constituent of the polymer binder 130. In another embodiment, the polymer binder 130 itself, in a liquid state prior to curing, may essentially act as the carrier solvent 160.

In various embodiments, the ink formulation 100 may be deposited using essentially any technique of patterning a substrate with an ink. For example, the ink formulation 100 may be drop coated on a substrate surface. Drop coating refers to coating the substrate or a portion thereof using drops of the ink formulation. That is, the ink formulation 100 typically including the carrier solvent 160 is formed into droplets. The drops are then directed toward, impacted upon and adhered to the substrate. For example, a pipet or an eye dropper containing the ink formulation 100 may be used to form the drops and gravity may be employed to propel the drops toward the substrate. In another example, drop coating is accomplished using an inkjet printer system (e.g., thermal inkjet printer). Yet other massively-parallel coating methods such as doctor-blade coating and gravure printing or coating may also be employed.

In drop coating using an inkjet printer system, the ink formulation 100 is loaded into an ink reservoir of an inkjet print head of the printer system. The inkjet print head under control of the inkjet printer is then employed to produce and propel droplets of the ink formulation 100 toward the substrate in a manner essentially similar to printing a pattern on a piece of paper using conventional ink. Specifically, the ink formulation 100 droplets are preferentially produced and propelled toward a region of the substrate that is within a defined boundary delineating the circuit element on the substrate. In addition, a sufficient quantity of droplets is applied by the print head such that the region of the substrate within the defined boundary is coated with an essentially continuous film of the ink formulation 100.

A specific amount or a particular thickness of the applied continuous film is dependent on a particular application and is related to a given loading or weight-percent (wt-%) of the powders 110, 120 in the ink formulation 100. In some embodiments, an applied film thickness is employed that is sufficient to yield an essentially continuous single layer (i.e., monolayer) of particles of the combined powders 110, 120 after removal of the carrier solvent 160 and after curing of the polymer binder 130. In other embodiments, the ink formulation 100 is applied having a film thickness such that multiple layers of particles are present in the deposited ink formulation 100 following carrier solvent 160 removal and polymer binder 130 curing.

For example, a film thickness of between about 50 nm and about 400 nm may yield from about 2 layers to about 5 layers of nano-sized particles in the deposited ink formulation 100 following carrier solvent 160 removal and polymer binder 130 curing. In other examples, film thicknesses up to about 2 microns and even greater is used. A number of layers produced is generally dependent on an average size of the particles in the powders 110, 120 as well as the weight-percent (wt-%) of the particles in the carrier solvent 160. In particular, whether or not a monolayer or multiple layers are present in the deposited ink formulation 100 after carrier solvent 160 removal and polymer binder 130 curing, in part depends on an average size of the particles employed. For example, depositing an ink formulation 100 comprising powders 110, 120 having 100 nm particles at a film thickness of 100 nm will generally yield a monolayer of the particles. In another example, employing particles with an average size that is smaller than 100 nm for the same 100 nm thick film will typically result in multiple layers of particles.

In some embodiments, the carrier solvent 160 is removed using evaporation. The carrier solvent 160 may be evaporated from the deposited ink formulation 100 by heating the substrate, for example. In particular, the substrate may be heated on a hot plate or in an oven to evaporate the carrier solvent 160. In some embodiments, a temperature below a boiling temperature of the carrier solvent 160 is employed to avoid either disturbing or disrupting a relatively continuous distribution of the particles within the deposited ink formulation 100 during carrier solvent 160 removal.

In some embodiments, the carrier solvent 160 further comprises a reagent, such as a surfactant. While a surfactant may be employed in the carrier solvent 160, in general a carrier solvent 160 prepared without a surfactant may avoid possible contamination of the resultant circuit element with the surfactant material following carrier solvent removal.

In general, a loading expressed as weight-percent (wt-%) of the first powder 110 and the second powder 120 in the ink formulation 100 greatly exceeds that of the polymer binder 130. For example, a combined loading of the first and second powders 110, 120 may be about 95 wt-% while that of the polymer binder is about 5 wt-% or less. In some embodiments, the loading of the first powder 110 may range from 35-65 wt-% while the loading of the second powder 120 ranges from 65-35 wt-%.

For example, the ink formulation 100 may comprise 60 wt-% indium (In) micro-particles as the first powder 110, 35 wt-% tin (Sn) micro-particles as the second powder 120, and 5 wt-% polyvinylpyrolidone as the polymer binder 130 all suspended and dissolved in isopropanol (IPA) as the carrier solvent 160. After deposition, removal by evaporation of the IPA carrier solvent 160, curing of the polyvinylpyrolidone polymer binder 130, and processing by heating in the presence of the oxidative environment, an indium tin oxide (ITO) circuit element is created. An ITO circuit element has been demonstrated with a volume resistivity of about 4 μOhms using gravure printing to deposit and define the circuit element.

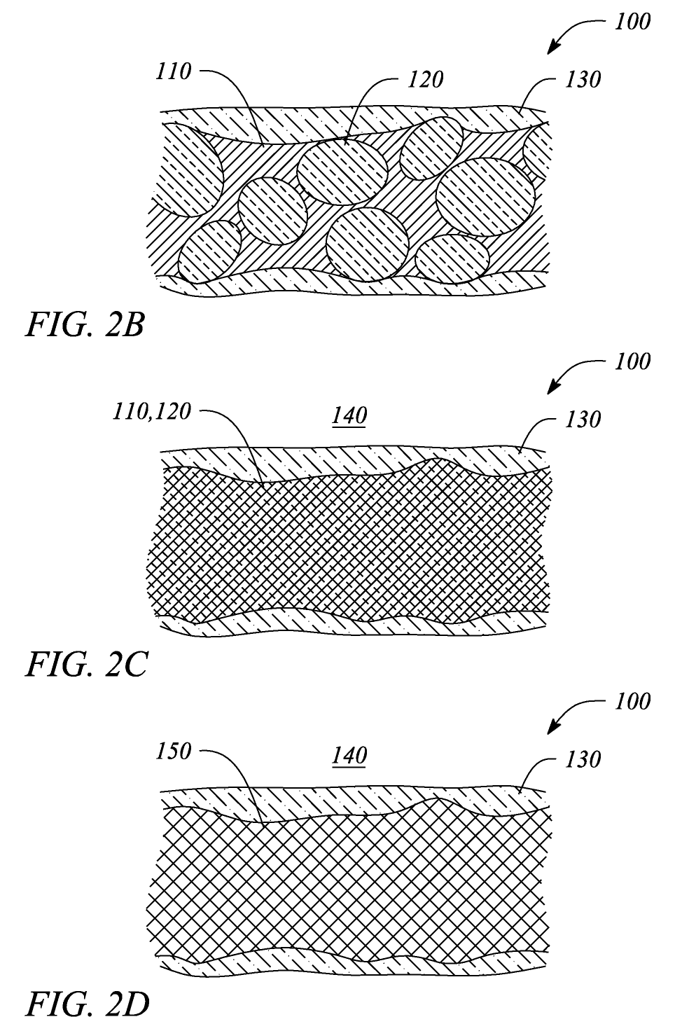

FIGS. 2A-2D illustrate a sequence of stages in fabricating an exemplary metal oxide circuit element according to an embodiment of the present invention. FIG. 2A illustrates the ink formulation 100 following deposition on a substrate and curing of the polymer binder 130. The deposited ink formulation 100 illustrated in FIG. 2A comprises particles of the first powder 110 and the second powder 120. The particles are bound together in a polymer matrix of the polymer binder 130. The polymer matrix both holds the particles together as well as provides substrate adhesion. The ink formulation 100 as illustrated in FIG. 2A may be deposited by gravure printing or screen printing, for example. Curing of the polymer binder 130 may be by heating the printed ink formulation 100 to evaporate the solvent and re-polymerize the polymer binder 130, for example.

FIG. 2B illustrates the deposited ink formulation 100 following application of heat sufficient to raise a temperature of the deposited ink formulation 100 to above the melting temperature of the first powder 110. As illustrated in FIG. 2B, the first powder 110 has melted and flowed into a region between particles of the second powder 120. Additionally, the polymer binder 130 has melted and has been moved out of the region between the second powder 120 particles by the melted first powder 110. In particular, the melted polymer binder 130 has moved to a periphery of the deposited ink formulation 100, as illustrated in FIG. 2B.

In some embodiments, the melted polymer binder 130 remains on the periphery and may continue to hold the powders 110, 120 together through surface tension, for example. In other embodiments (not illustrated), the polymer binder 130 dissipates by one or more of evaporation, sublimation and decomposition and is not present on the periphery after melting.

FIG. 2C illustrates the deposited ink formulation 100 following application of heat sufficient to further raise the temperature of the ink formulation 100 to above the melting temperature of the second powder 120. The melted first and second powders 110,120 mix together and form a solid solution. Also illustrated in FIG. 2C is the oxidative environment 140. The oxidative environment 140 oxidizes the melted first and second powders 110, 120.

FIG. 2D illustrates the deposited ink formulation 100 after oxidation of the melted first and second powders 110, 120 by the oxidative environment 140. Oxidation produces the metal oxide 150 of the metal oxide circuit element. For example, the melted first and second powders 110, 120 may comprise indium (In) and tin (Sn), respectively. The InSn alloy formed by the mixing of the melted powders 110, 120 forms an indium tin oxide (ITO) 150 when exposed to the oxidative environment 140. Further heat may be applied to the melted powders 110, 120 in the presence of the oxidative environment 140 to facilitate oxidation, for example.

In some embodiments (not illustrated), the second powder 120 is not melted and the oxidative environment oxidizes only the melted first powder 110. For example, the first powder 110 may comprise zinc (Zn) nanoparticles and the second powder 120 may comprise zinc oxide (ZnO) particles. The melted Zn nanoparticles flow around the ZnO particles and are oxidized by the oxidative environment 140 to form a ZnO matrix in the spaces between the ZnO particles of the second powder 120. The formed ZnO matrix mechanically and electrically interconnects the ZnO particles of the second powder 120 to produce the metal oxide circuit element. In another example, the first powder 110 comprises tin (Sn) particles and the second powder 120 comprises tin oxide (SnO) particles. The Sn particles are melted and oxidized by the oxidative environment 140 to interconnect the SnO particles.

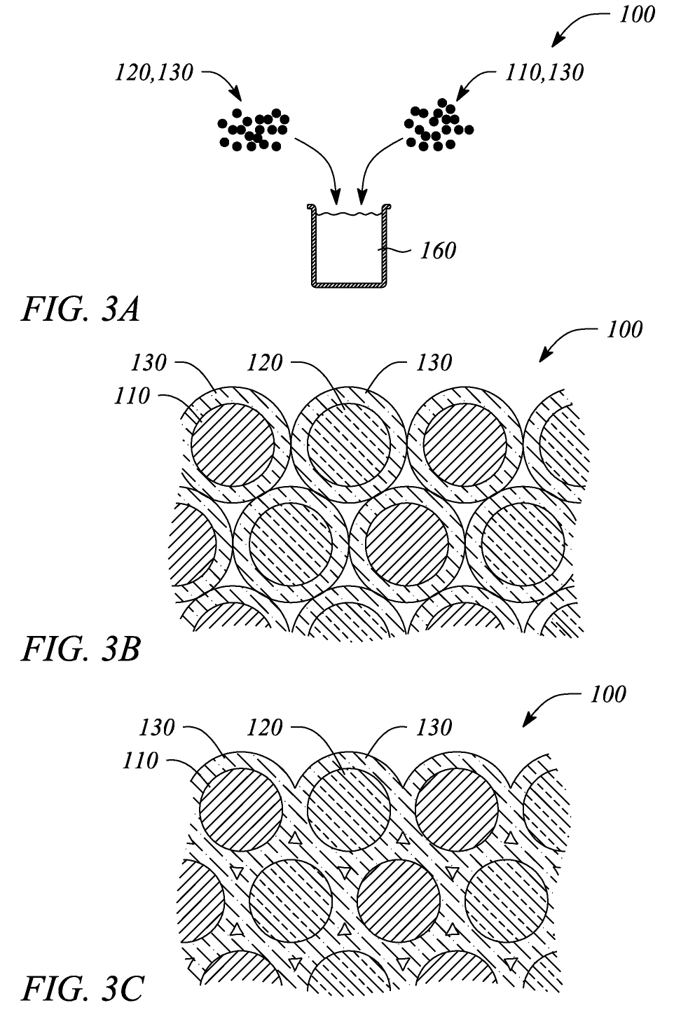

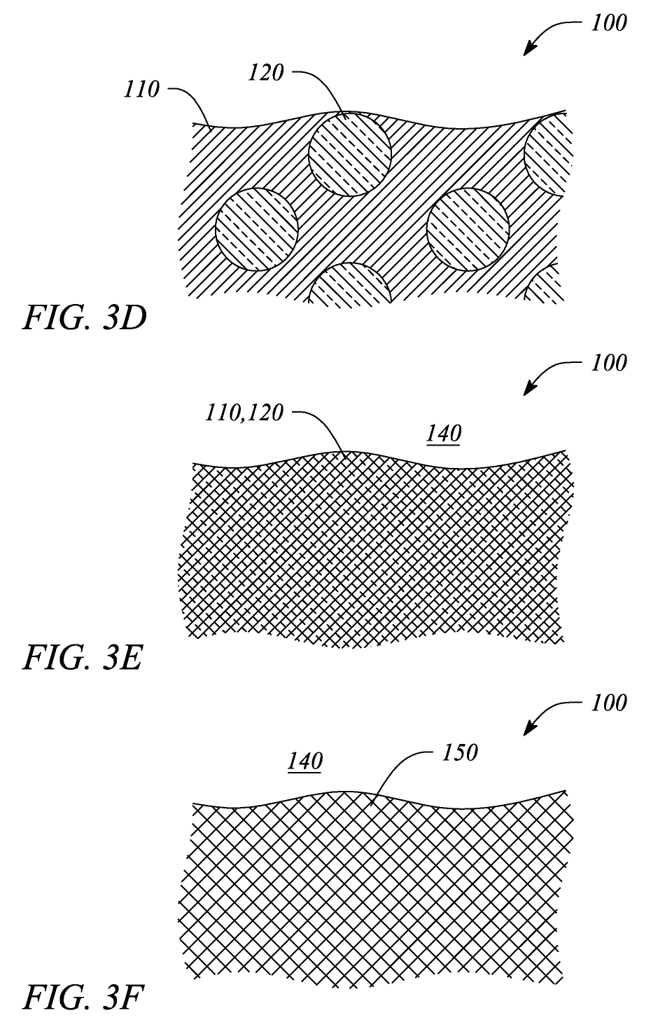

FIGS. 3A-3F illustrate a sequence of stages of fabricating an exemplary circuit element according to another embodiment of the present invention. In particular, the sequence illustrated in FIGS. 3A-3F employ the first powder 110 and the second powder 120 encapsulated by the polymer binder 130 prior to use. As illustrated in FIG. 3A, the encapsulated powders 110, 120 are added to and suspended in a simple carrier solvent 160 (e.g., H₂O) using ultrasonification to minimize agglomeration of the particles. The ink formulation 100 so formed is then deposited on a substrate (not illustrated). For example, the ink formulation 100 may be deposited by one of gravure printing, thermal ink-jetting, screen-printing, dip-coating, spin-coating, imprinting and laminating.

FIG. 3B illustrates the ink formulation 100 of FIG. 3A following deposition on a substrate. FIG. 3C illustrates the deposited ink formulation 100 following application of heat to sinter the encapsulated first and second powders 110, 120. In particular, as illustrated in FIG. 3C, the encapsulating polymer binder 130 of adjacent particles has merged.

FIG. 3D illustrates the ink formulation 100 of FIG. 3C after an application of sufficient heat to melt the first powder 110. The melted first powder 110 has flowed into the spaces between the particles of the second powder 120. Moreover, the polymer binder 130 has been displaced by the melted first powder 110 so that the polymer binder 130 no longer encapsulates the particles of the second powder 120. In the embodiment illustrated in FIG. 3D, the polymer binder 130 has dissipated and is no longer present.

FIG. 3E illustrates the ink formulation 100 of FIG. 3C following an application of heat sufficient to melt the second powder 120. A solid solution of the first and second powders 110, 120 has been formed in FIG. 3E.

In some embodiments, the solid solution illustrated in FIG. 3E is cooled and employed as a circuit element without exposure to an oxidative environment. As such, the circuit element so formed may comprise a metal as opposed to a metal oxide. For example, the first powder 110 may comprise indium (In) and the second powder 120 may comprise tin (Sn). The solid solution or alloy formed is indium tin (InSn) which may be employed as a conductive interconnect, for example. In another example, the first powder 110 comprises indium (In) while the second powder 120 comprises gallium (Ga) yielding a solid solution of indium gallium (InGa).

Also illustrated in FIG. 3E is the oxidative environment 140 that may be present according to other embodiments. When present, the oxidative environment 140 oxidizes the melted first and second powders 110, 120.

FIG. 3F illustrates the ink formulation 100 of FIG. 3E after oxidation by the oxidative environment 140. The solid solution of the melted first powder 110 and the melted second powder 120 of FIG. 3E has been completely transformed into a metal oxide 150 by the exposure to the oxidative environment 140, as illustrated in FIG. 3F. For example, the solid solution of indium gallium (InGa) may be completely transformed into InGaO by the exposure to the oxidative environment 140.

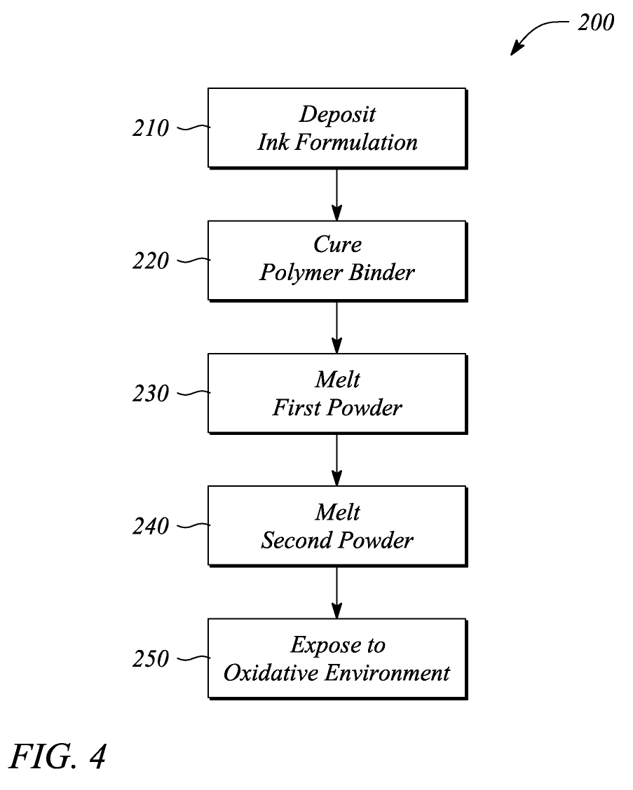

FIG. 4 illustrates a flow chart of a method 200 of fabricating a circuit element on a substrate according to an embodiment of the present invention. As illustrated in FIG. 4, the method 200 of fabricating comprises depositing 210 an ink formulation on the substrate. In various embodiments, the ink formation is deposited 210 using one or more of essentially any technique of patterning a substrate with an ink. For example, one or more of gravure printing, drop coating, thermal inkjet printing, screen printing, dip-coating, spin coating, imprinting (e.g., imprint lithography), and laminating may be employed in depositing 210 the ink formulation.

In some embodiments, the ink formulation comprises a first metal powder having a first melting temperature and a second powder having a second melting temperature that is higher than the first melting temperature. The ink formulation further comprises a polymer binder. In some embodiments, the ink formulation is essentially similar to the ink formulation 100 described above. Furthermore, the first powder, second powder and polymer binder are essentially similar to the first powder 110, second powder 120 and polymer binder 130, respectively. For example, the first powder may be a metal powder, the second powder may be either a metal or a metal oxide powder and the polymer binder may be a thermoplastic polymer.

The method 200 of fabricating a circuit element further comprises curing 220 the polymer binder. Curing 220 the polymer binder binds together particles of the first metal powder and the second powder in close proximity to one another. In particular, curing 220 establishes a polymer matrix that holds the particles together. As a result of curing 220, particles of the first and second powders are bound together in the polymer matrix.

In some embodiments, curing 220 comprises heating the ink formulation to remove a solvent from the ink formulation. Removing the solvent results in polymerization or re-polymerization of the polymer binder to produce or establish the polymer matrix. In some embodiments, curing 220 combines precursors to produce the polymer matrix of the polymer binder. For example, curing 220 may comprise heating the deposited ink formulation to a curing temperature that is less than the melting temperature of the first powder. In another example, curing may comprise adding a curing agent to the deposited ink formulation. In some embodiments, curing the polymer binder is essentially similar to curing the polymer binder 130 described above with respect to the ink formulation 100.

In some embodiments, the polymer binder encapsulates particles of one or both of the first powder and the second powder. In such embodiments, curing 220 comprising treating the encapsulating polymer binder to fuse adjacent particles to one another. Treating may include heating the polymer binder to at least a glass transition temperature of a polymer compound of the polymer binder, for example. In another example, treating comprises partially melting the encapsulating polymer binder with a solvent to allow adjacent encapsulated particles to merge.

The method 200 of fabricating a circuit element further comprises melting 230 the bound first powder. In some embodiments, melting 230 the bound first powder comprises heating the deposited ink formulation to a temperature that is at or just above the melting temperature of the first powder. Heating may comprise ramping the temperature to the melting temperature of the first powder and then holding the temperature for a hold time, for example. The combination of the temperature and the hold time should be sufficient to fully melt the first powder. The hold time may be from 0.5 seconds to 10 seconds, in some embodiments, while the ramp time may be from 0 to 5 seconds, in some embodiments. Longer and shorter hold times and longer or shorter ramp times may be employed depending on size and thickness of the deposited ink formulation as well as material characteristics of the first powder.

In some embodiments, the method 200 of fabricating a circuit element further comprises melting 240 the bound second powder after the first powder has been melted 230. In some embodiments, melting 240 the bound second powder comprises heating the deposited ink formulation to a temperature that is at or just above the melting temperature of the second powder. Heating may comprise ramping the temperature to the melting temperature of the second powder and then holding the temperature for a hold time sufficient to fully melt the second powder, for example. The hold time may be from 0.5 to 10 seconds, in some embodiments, while the ramp time may be from 0 to 5 seconds, in some embodiments. Longer and shorter hold times and longer or shorter ramp times may be employed. In other embodiments, melting 240 the second powder is optional.

In some embodiments when both the first powder and the second powder are fully melted, the melted powders form a solid solution. The solid solution produces the circuit element when cooled. In an example wherein both of the powders comprise a metal, the solid solution is a metal alloy and the circuit element is a conductor.

In some embodiments, the method 200 of fabricating a circuit element further comprises exposing 250 either the melted first powder alone or the melted first powder and the melted second powder to an oxidative environment. Exposure 250 to the oxidative environment results in the creation of an oxide of the solid solution. If one or both of the first powder and the second powder are metals, a metal oxide is created. In such embodiments, the circuit element fabricated by the method 200 comprises a metal oxide circuit element. The metal oxide so formed may be either a conductor (e.g., ITO) or a semiconductor (e.g., ZnO). In some embodiments, exposing 250 is essentially similar to that described above for the oxidative environment 140 with respect to the ink formulation 100.

In a first example, the oxidative environment comprises the polymer binder in contact with the formed solid solution wherein the polymer binder provides part or all of the oxygen (O) used to oxidize the solid solution. In some embodiments, the polymer binder has a high oxygen content such as polyvinyl alcohol, for example. In another example, the oxidative environment comprises an oxygen rich atmosphere surrounding the deposited ink formulation at least while either the first powder or the first and second powders are melted 230, 240. In yet another example, both the polymer binder and atmospheric oxygen facilitate oxidation of the powder(s).

Thus, there have been described embodiments of an ink formulation for fabricating a metal circuit element and a metal oxide circuit element as well as a method of making a circuit element using the ink formulation. It should be understood that the above-described embodiments are merely illustrative of some of the many specific embodiments that represent the principles of the present invention. Clearly, numerous other arrangements may be readily devised without departing from the scope of the present invention as defined by the following claims.

What is claimed is:

1. An ink formulation of a metal oxide circuit element, the ink formulation comprising:
a first powder that comprises particles of a metal having a first melting temperature;
a second powder that comprises particles having a second melting temperature that is higher than the first melting temperature;
a polymer binder; and
an oxidative environment,
wherein when cured, the cured polymer binder binds together in close proximity the particles of the first powder and the particles of the second powder, and wherein when melted in the oxidative environment, the melted particles of the first powder form the metal oxide circuit element.

2. The ink formulation of claim 1, further comprising a carrier solvent that suspends the first powder, the second powder and the polymer binder.

3. The ink formulation of claim 1, wherein the oxidative environment comprises an oxygen rich atmosphere surrounding the ink formulation at one or both of the first melting temperature and the second melting temperature.

4. The ink formulation of claim 1, wherein the oxidative environment comprises the polymer binder.

5. The ink formulation of claim 1, wherein the polymer binder comprises an encapsulating polymer that encapsulates particles of one or both of the first powder and the second powder, the encapsulating polymer being partially melted with the application of heat to fuse the encapsulating polymer of adjacent particles.

6. The ink formulation of claim 1, wherein the polymer binder comprises a polymer precursor that transforms into a polymer compound of the polymer binder.

7. The ink formulation of claim 1, wherein the second powder comprises a metal.

8. The ink formulation of claim 1, wherein the second powder comprises a metal oxide.

9. The ink formulation of claim 1, wherein one or both of the first powder and the second powder comprise nanoparticles.

10. An ink formulation to form a circuit element on a substrate, the ink formulation comprising:
a first metal powder having a first melting temperature;
a second powder having a second melting temperature, the second melting temperature being higher than the first melting temperature; and
a polymer that is a thermoplastic, respective particles of the first metal powder and the second powder being encapsulated by the polymer, wherein one of the first metal powder being melted and both the first metal powder and the second powder being melted forms the circuit element.

11. The ink formulation of claim 10, further comprising a carrier solvent, wherein the first metal powder and the second powder are suspended in the solvent prior to deposition on the substrate.

12. The ink formulation of claim 10, wherein the thermoplastic polymer fuses adjacent encapsulated particles of the first metal powder and the second powder together at a glass transition temperature of the thermoplastic polymer, the glass transition temperature being less than the first melting temperature.

13. The ink formulation of claim 10, further comprising an oxidative environment, one or both of the first metal powder and a combination of the first metal powder and the second powder forming a metal oxide at a respective melting temperature in the oxidative environment.

14. The ink formulation of claim 13, wherein the second powder comprises one or both of metal particles and metal oxide particles.

15. A method of fabricating a circuit element on a substrate, the method comprising:
depositing an ink formulation on the substrate, the ink formulation comprising:
a first powder having a first melting temperature, the first powder comprising a metal;
a second powder having a second melting temperature that is higher than the first melting temperature; and
a polymer binder;
curing the polymer binder to bind together particles of the first powder and particles of the second powder in close proximity to one another on the substrate;
melting the bound first powder; and
melting the bound second powder,
wherein the melted first powder and the melted second powder form a solid solution that yields the circuit element.

16. The method of fabricating a circuit element of claim 15, further comprising exposing to an oxidative environment either the melted first powder alone or a combination of the melted first powder and the melted second powder to create an oxide of the solid solution, wherein the fabricated circuit element comprises a metal oxide.

17. The method of fabricating a circuit element of claim 16, further comprising exposing the solid solution to an oxidative environment, the polymer binder in contact with the solid solution providing the oxidative environment.

18. The method of fabricating a circuit element of claim 15, wherein melting the bound first powder and melting the bound second powder comprise ramping a temperature to the first melting temperature; holding the substrate temperature at the first melting temperature for a hold time; ramping the substrate temperature to the second melting temperature; and holding the substrate temperature at the second melting temperature for a second hold time.

19. The method of fabricating a circuit element of claim 15, wherein the polymer binder encapsulates particles of one or both of the first powder and the second powder, curing the polymer binder comprising treating the polymer binder to fuse adjacent encapsulated particles to one another, and wherein melting the second powder is optional.

20. The method of fabricating a circuit element of claim 15, wherein depositing the ink formulation on the substrate comprises using one or more of screen printing, gravure printing, inkjet printing, electro-deposition, dip-coating, spin-coating, imprinting and laminating.

21. A method of fabricating a metal oxide circuit element on a substrate, the method comprising:
depositing an ink formulation on the substrate, the ink formulation comprising:
a first powder having a first melting temperature, the first powder comprising a metal;
a second powder having a second melting temperature that is higher than the first melting temperature; and
a polymer binder;
curing the polymer binder to bind together particles of the first powder and particles of the second powder in close proximity to one another;
melting the first powder; and
exposing the melted first powder to an oxidative environment,
wherein the melted first powder is oxidized by the oxidative environment to form the metal oxide circuit element.

22. The method of fabricating a metal oxide circuit element of claim 21, wherein the second powder comprises a metal, the method further comprising melting the second powder and further exposing the melted second powder to the oxidative environment to oxidize the metal of the melted second powder.

23. The method of fabricating a metal oxide circuit element of claim 21, wherein the polymer binder encapsulates one or both of the first powder and the second powder prior to deposition on the substrate.
